(19) United States
(12) Patent Application Publication
(10) Pub. No.: US 2012/0071084 A1
(43) Pub. Date: Mar. 22, 2012

(54) COVERAGE GAP MITIGATION FOR WIDE BROADCAST AREA NETWORKS

(75) Inventors: Ralph A. Gholmieh, San Diego, CA (US); Binita Gupta, San Diego, CA (US)

(73) Assignee: QUALCOMM Incorporated, San Diego, CA (US)

(21) Appl. No.: 12/887,373

(22) Filed: Sep. 21, 2010

(51) Int. Cl. H04H 20/71

(52) U.S. Cl. 455/3.01

(57) ABSTRACT

Systems, methods, devices, and computer program products are described for wireless broadcast system provisioning. In such a system, there may be a number of wide broadcast areas. Within each wide broadcast area, there may be a number of local broadcast areas. Wide broadcast area content may be assigned to a wide broadcast area scrambling differentiator. The scrambling differentiator may be assigned to a carrier tag. The association between the wide broadcast area content, wide broadcast area scrambling differentiator, and the carrier tag may be common across neighboring wide broadcast areas. Data may be transmitted in a wide broadcast area control channel to identify the association between the carrier tag and the wide broadcast area scrambling differentiator.

### BACKGROUND

The following relates generally to wireless communications systems, and more specifically to provisioning in wide broadcast area networks. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, 3GPP Long Term Evolution (LTE) systems, and orthogonal frequency-division multiple access (OFDMA) systems.

As noted, some wireless communications systems operate as broadcast systems, broadcasting live and replayed programming, clips, and data to a range of mobile devices. One example of such a system is the MediaFLO™ system. In such systems, there may be a number of wide broadcast areas, and wide broadcast area content (e.g., national TV stations) may be broadcast across the wide broadcast area. Within each wide broadcast area, there may also be a number of local broadcast areas. In addition to receiving the wide broadcast area content, each local area may receive local broadcast area content that is unique to the local broadcast area. A local broadcast area control channel may carry local broadcast area content provisioning information, as well as a carrier mapping for the local broadcast area.

In some cases, a mobile device may not be able to acquire the local broadcast area control channel. However, a wide broadcast area control channel may be available. Nonetheless, because the carrier mapping for the wide broadcast area is often carried in the local broadcast area control channel, a mobile device may be unable to access the wide broadcast area content. Thus, there may be a need for novel provisioning schemes to address the coverage gaps that may arise in such situations.

### SUMMARY

The described features generally relate to one or more improved systems, methods, and/or apparatuses for provisioning in wireless broadcast communications systems. Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

Systems, methods, devices, and computer program products are described for wireless broadcast system provisioning in systems with wide and local broadcast areas. In one example, there are a number of wide broadcast areas. Within each wide broadcast area, there may be a number of local broadcast areas. Wide broadcast area content may be assigned to a wide broadcast area scrambling differentiator. The wide broadcast area scrambling differentiator may be assigned to a carrier tag. The association between the wide broadcast area content, wide broadcast area scrambling differentiator, and the carrier tag may be common across neighboring wide broadcast areas. The association between the carrier tag and the wide broadcast area scrambling differentiator may be transmitted in a wide broadcast area control channel.

An exemplary method for generating tags for a broadcast communications system includes: identifying a plurality of wide broadcast areas; identifying a plurality of local broadcast areas within each of at least a subset of the wide broadcast areas; assigning wide broadcast area content to a wide broadcast area scrambling differentiator, the wide broadcast area content assignment common across at least two neighboring wide broadcast areas of the plurality of wide broadcast areas; assigning the wide broadcast area scrambling differentiator to a carrier tag, the wide broadcast area scrambling differentiator assignment to the carrier tag common across the at least two neighboring wide broadcast areas; and transmitting data in a wide broadcast area control channel identifying an association between the carrier tag and the wide broadcast area scrambling differentiator.

Examples of such a method may include one or more of the following features: assigning a same wide broadcast area scrambling differentiator to the carrier tag across each of the plurality of local broadcast areas within the two neighboring wide broadcast areas; assigning a same wide broadcast area scrambling differentiator to the carrier tag across in each of the plurality of wide broadcast areas; assigning different carriers to the carrier tag in each of a plurality of neighboring local broadcast areas of the plurality of local broadcast areas; or assigning a carrier to the carrier tag, the carrier assignment common across a plurality of neighboring local broadcast areas within at least one of the wide broadcast areas. The broadcast communication system may be a MediaFLO system, the plurality of wide broadcast areas may each correspond to a different wide-area operational infrastructure, and the plurality of local broadcast areas may each correspond to a different local-area operational infrastructure. The wide broadcast area scrambling differentiator may be a wide area differentiator, and the carrier tag may be an RF channel ID.

Examples of such a method may also or alternatively include one or more of the following features: transmitting data identifying the carrier assignment for neighboring local broadcast areas in a local broadcast area control channel, wherein the carrier tag is generated as a function of the wide broadcast area scrambling differentiator; transmitting data identifying the carrier assignment for a local broadcast area in a local broadcast area control channel, wherein a mobile device acquiring the wide broadcast area control channel is unable to acquire the local broadcast area control channel and uses a previously received neighbor list including the carrier assignment to receive the wide broadcast area content; or generating the carrier tag as a function of the wide broadcast area scrambling differentiator, wherein the carrier tag includes the wide broadcast area scrambling differentiator.

An exemplary system of generating tags for a broadcast communications system includes: a wide content identification module configured to identify wide broadcast area content to be transmitted to a plurality of wide broadcast areas, each of at least a subset of the wide broadcast areas including a plurality of local broadcast areas; a wide scrambling differentiator assignment module, communicatively coupled with the wide content identification module, and configured to assign the identified wide broadcast area content to a wide broadcast area scrambling differentiator, the wide broadcast area content assignment common across at least two neighboring wide broadcast areas of the plurality of wide broadcast areas; a carrier tag assignment module, communicatively coupled with the wide scrambling differentiator assignment module, and configured to assign the wide broadcast area scrambling differentiator to a carrier tag, the wide broadcast area scrambling differentiator assignment to the carrier tag common across the at least two neighboring wide broadcast areas; and a wide broadcast area transmitter configured to transmit data in a wide broadcast area control channel identifying an association between the carrier tag and the wide broadcast area scrambling differentiator.

Examples of such a system may further include the carrier tag assignment module configured to: assign a same wide broadcast area scrambling differentiator to the carrier tag across each of the plurality of local broadcast areas within the two neighboring wide broadcast areas; assign a same wide broadcast area scrambling differentiator to the carrier tag across in each of the plurality of wide broadcast areas; and generate the carrier tag as a function of the wide broadcast area scrambling differentiator, wherein the carrier tag may include the wide broadcast area scrambling differentiator.

Such a system may, also or alternatively, include the carrier assignment module configured to assign different carriers to the carrier tag in the plurality of local broadcast areas. The local broadcast area transmitter may be configured to transmit data identifying the carrier assignment for a local broadcast area in a local broadcast area control channel, wherein a mobile device acquiring the wide broadcast area control channel is unable to acquire the local broadcast area control channel and uses a previously received carrier assignment to receive the wide broadcast area content. The local broadcast are transmitter may further be configured to transmit data identifying the carrier assignment for neighboring local broadcast areas in a local broadcast area control channel. The system may also include a carrier assignment module, communicatively coupled with the carrier tag assignment module, and configured to assign a carrier to the carrier tag, the carrier assignment common across each of the plurality of local broadcast areas within at least one of the wide broadcast areas.

An exemplary apparatus for generating tags for a broadcast communication system includes: means for identifying a plurality of wide broadcast areas; means for identifying a plurality of local broadcast areas within each of at least a subset of the wide broadcast areas; means for assigning wide broadcast area content to a wide broadcast area scrambling differentiator, the wide broadcast area content assignment common across at least two neighboring wide broadcast areas of the plurality of wide broadcast areas; means for assigning the wide broadcast area scrambling differentiator to a carrier tag, the wide broadcast area scrambling differentiator assignment to the carrier tag common across two neighboring wide broadcast areas of the plurality of wide broadcast areas; and means for transmitting data in a wide broadcast area control channel identifying an association between the carrier tag and the wide broadcast area scrambling differentiator. The means for assigning the wide broadcast area scrambling differentiator to the carrier tag may include means for assigning a same wide broadcast area scrambling differentiator to the carrier tag across each of the plurality of local broadcast areas within the two neighboring wide broadcast areas.

Examples of such an apparatus may, also or alternatively, include one or more of the following: means for assigning different carriers to the carrier tag in two or more local broadcast areas of the plurality of local broadcast areas; means for transmitting data identifying the carrier assignment for a local broadcast area in a local broadcast area control channel, wherein, a mobile device acquiring the wide broadcast area control channel and unable to acquire a local broadcast area control channel uses a previously received neighbor list including a carrier assignment to receive the wide broadcast area content; or means for generating the carrier tag as a function of the wide broadcast area scrambling differentiator, wherein the carrier tag may include the wide broadcast area scrambling differentiator.

An exemplary computer program product for wireless broadcast system provisioning in systems with wide and local broadcast areas includes a computer program product residing on a tangible processor-readable medium and comprising processor-readable instructions configured to cause a processor to: identify a plurality of wide broadcast areas; identify a plurality of local broadcast areas within each of at least a subset of the wide broadcast areas; assign wide broadcast area content to a wide broadcast area scrambling differentiator, the wide broadcast area content assignment common across at least two neighboring wide broadcast areas of the plurality of wide broadcast areas; assign the wide broadcast area scrambling differentiator to a carrier tag, the wide broadcast area scrambling differentiator assignment to the carrier tag common across two neighboring wide broadcast areas of the plurality of wide broadcast areas; and transmit data in a wide broadcast area control channel identifying an association between the carrier tag and the wide broadcast area scrambling differentiator.

An exemplary system for provisioning includes: a network operations center configured to identify a plurality of wide broadcast areas; identify a plurality of local broadcast areas within each of at least a subset of the wide broadcast areas; assign wide broadcast area content to a wide broadcast area scrambling differentiator, the wide broadcast area content assignment common across at least two neighboring wide broadcast areas of the plurality of wide broadcast areas; and assign the wide broadcast area scrambling differentiator to a carrier tag, the wide broadcast area scrambling differentiator assignment to the carrier tag common across two neighboring wide broadcast areas of the plurality of wide broadcast areas. The system may further include a wide broadcast area transmitter in communication with the network operations center, and configured to transmit data in a wide broadcast area control channel identifying an association between the carrier tag and the wide broadcast area scrambling differentiator; and a mobile device configured to wirelessly receive the a wide broadcast area control channel.

The network operations center may further be configured to assign different carriers to the carrier tag in each of a plurality of neighboring local broadcast areas of the plurality of local broadcast areas. Also or alternatively, examples of the system may include a local broadcast area transmitter in communication with the network operations center, and configured to transmit data identifying the carrier assignment for a local broadcast area in a local broadcast area control channel. The mobile device may further be configured to use a cached carrier assignment received via the local control channel to receive the wide broadcast area content if unable to acquire the local broadcast area control channel in real-time. The local broadcast area transmitter may be remote from the network operations center and the wide broadcast area transmitter. The local broadcast area transmitter may transmit data identifying the carrier assignment for neighboring local broadcast areas in a local broadcast area control channel. The mobile device may further be configured to use a cached list of neighbor carrier assignments received via the local control channel to receive the wide broadcast area content if the mobile device is unable to acquire the local broadcast area control channel in real-time.

### BRIEF DESCRIPTION OF THE DRAWINGS

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram illustrating an example of a mobile broadcast system.

FIG. 2 is a block diagram illustrating an exemplary architecture for a MediaFLO system.

FIG. 3 is a block diagram illustrating exemplary wide and local broadcast areas.

FIG. 4 is a block diagram illustrating an example of a system for wireless broadcast network provisioning.

FIG. 5 is a block diagram illustrating an exemplary mobile device.

FIG. 6 is a flowchart illustrating a method for distributing wide broadcast area control channel information.

FIG. 7 is a flowchart illustrating a method for distributing wide and local broadcast area control channel information.

FIG. 8 is a flowchart illustrating an alternative method for distributing wide and local broadcast area control channel information.

FIG. 9 is a schematic diagram of an example computer system architecture that may be utilized to implement the systems or methods described herein.

### DETAILED DESCRIPTION

Systems, methods, devices, and computer program products are described for wireless broadcast system provisioning. In such a system, there may be a number of wide broadcast areas. Within each wide broadcast area, there may be a number of local broadcast areas. Wide broadcast area content may be assigned to a wide broadcast area scrambling differentiator. The scrambling differentiator may be assigned to a carrier tag. While carrier mappings may vary, the association between the wide broadcast area content, wide broadcast area scrambling differentiator, and the carrier tag may be common across neighboring wide broadcast areas. A wide broadcast area control channel may identify the association between the carrier tag and the wide broadcast area scrambling differentiator. Reception of this wide broadcast area control channel may allow mobile devices to receive wide broadcast area content when the local control channel cannot be acquired (e.g., using a cached local broadcast area control channel information).

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

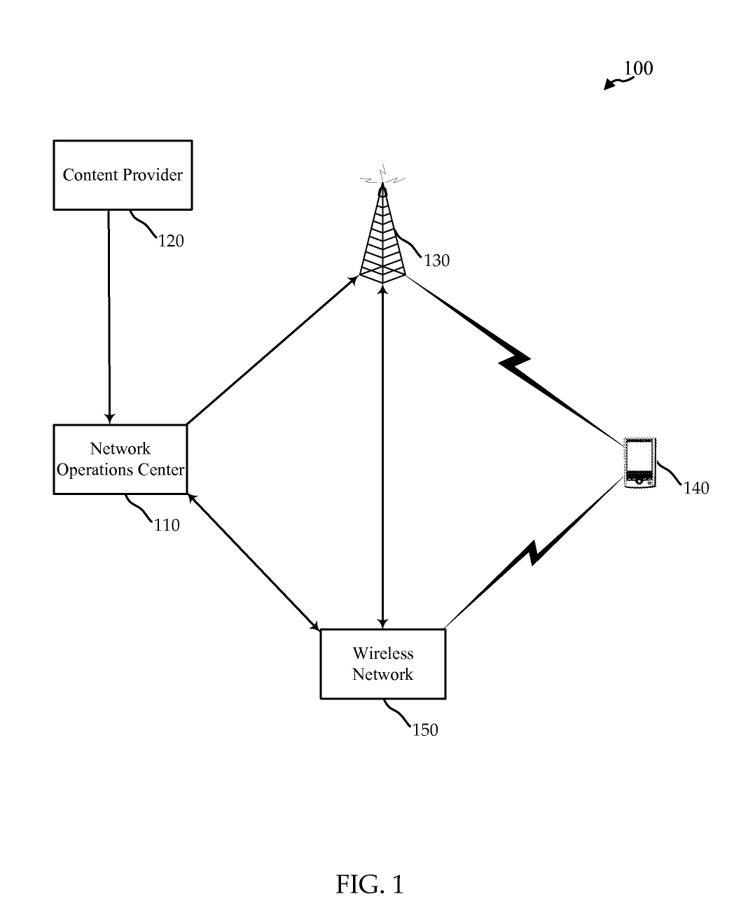

FIG. 1 is a block diagram showing an example wireless mobile broadcast system 100. The mobile broadcast system 100 may operate in accordance with the standards published by the FLO forum, and in particular typified by the MediaFLO™ broadcast system by Qualcomm Incorporated of San Diego, Calif. Using a cellular standard, such as GSM or CDMA may enable MediaFLO to provide security and services utilizing unicasting associated with a wireless paradigm. The MediaFLO mobile broadcast platform delivers content across a mobile environment. MediaFLO utilizes a combination of broadcast and wireless paradigms to provide business opportunities within a mobile broadcast ecosystem. Using the Forward Link Only (FLO) air interface standard, MediaFLO provides greater content capacity and reduced content delivery costs associated with broadcasting paradigms.

MediaFLO, or FLO™, technology is designed to meet the mobile entertainment requirements of end users and service providers by, for example, providing television services to end users and features designed to facilitate monetization by service providers. MediaFLO provides a broad range of content to mobile devices in a manner which is spectrally efficient, cost-effective, and designed for low power consumption system. For example, the MediaFLO system may deliver streaming television, video and audio, Clipcast™ video and audio, and real-time Internet Protocol (IP) data services to MediaFLO compatible mobile devices. The mobile devices may selectively receive, display, play, store, and manipulate the content delivered over the mobile broadcast system 100. Mobile devices 140 usable with the MediaFLO system include smartphones, cellular phones, personal digital assistants (PDA), interactive game devices, notebooks, smartbooks, netbooks, or other such electronic devices.

MediaFLO also may be configured to group programming into one or more subscription packages. Users, or subscribers, operating MediaFLO compatible mobile devices may select one or more of the MediaFLO subscription packages. For example, reception and decoding of channels included in a MediaFLO subscription package may be enabled in response to user input, e.g., touching a touchscreen on a MediaFLO compatible mobile device. Any number of conditional access solutions (CAS) may be utilized for controlling access to MediaFLO content and services. Additionally, the mobile broadcast system 100 may maintain quality by providing service flexibility with variable bit rate encoding. Variable bit rate encoding balances bandwidth with high-quality audio and video.

MediaFLO end user services may include real-time content delivery, such as video and audio presentations, audio only programming and audio with slides programming. In some implementations, the real-time services may include enhanced H.264 video and AAC+ audio formats. End user services also may include non-real-time content delivery, such as network scheduled delivery of audio clips, e.g., MP4, and multimedia files, e.g., JPEG, PNG and HTML. Non-real-time services generally entail the mobile device capturing specific pieces of multimedia and other data for presentation at a later time. For example, a non-real-time service called “clipcasting” provides network scheduled delivery of data services and files, such as wallpaper or e-coupons, for capture by a mobile device. Additionally, Clipcast may be implemented to deliver multimedia clips with multi-presentation views, e.g., from a plurality of perspectives, to a mobile device in accordance with a network schedule.

The mobile broadcast system 100 also may enable audio and video clips, or multimedia clips, to be stored at the MediaFLO compatible mobile device in internal memory, external memory, or both. End users may view, listen to, and play any stored clip that has not expired. In some implementations, the mobile device may include a file cache size that is configurable by the service operator, the end user, or both.

Additionally, MediaFLO may offer end user IP data services, such as FLO network delivery of Internet traffic to third-party applications. Third-party mobile applications may provide end users with dynamic home pages, that include, e.g., stock, news, weather, and sports information. For example, the delivery of IP data services may enable stock tickers to be tailored to a user's specific profile. Additionally, MediaFLO may be integrated with two-way data exchange applications, such as text and voice chat, live voting, email and web browsing, video-on-demand and shopping, in addition to other interactive mobile application features. With such interactivity, a user may obtain additional information associated with the real-time or non-real-time programming. For example, a dinner recipe may be downloaded during the broadcast of a cooking show and shared with a user's friends, e.g., via an SMS message.

Referring once again to FIG. 1, the mobile broadcast system 100 generally includes multiple nodes 110-140 that may communicate, in whole or in part, over a wireless network 150. The wireless network 150, also referred to as a “wireless communications system,” encompasses both the physical network as well as digital signal technology. The wireless network 150 may be implemented as: a CDMA system; an FDMA system; a TDMA system such as GSM, GSM/General Packet Radio Service (GPRS), Enhanced Data GSM Environment (EDGE) or Terrestrial Trunked Radio (TETRA); a WCDMA system; Evolution Data Optimized (EV-DO) systems such as 1xEV-DO, EV-DO Rev A or EV-DO Rev B; High Speed Packet Access (HSPA) systems such as High Speed Downlink Packet Access (HSDPA), High Speed Uplink Packet Access (HSUPA) or Evolved High Speed Packet Access (HSPA+); an LTE system; or other communications systems, such as a system utilizing 3G or 4G technology. Content distributed over the interconnected nodes 110-140 may be selectively received, transmitted, processed, stored, and displayed.

The nodes of the mobile broadcast system 100 generally may include a network operations center 110, one or more content providers 120, one or more transmitters 130, and a number of mobile devices 140. The network operations center 110 may include one or more receivers (not shown) configured to receive content from one or more content providers 120. In some implementations, the receivers may reside at the network operations center 110. For example, the network operations center 110 may include a C-band receiver configured to receive content delivered by a C-band satellite content provider 120. In other implementations, the receivers may be located remotely from the network operations center 110 and may deliver the received content to the network operations center 110 using wired or wireless technology. The content received from the one or more content providers 120 may include local and national content. The local and national content may include real-time, non-real-time and IP data services content.

The real-time content may be received from C-band and Ku-band satellites, terrestrial broadcast transmitters, and data networks, in addition to other such transmitting devices and networks. The real-time content may include video, such as MPEG-2 over asynchronous serial interface, or YUV over serial digital interface. The real-time content also may include audio, such as AC-3 or MP2 over ASI, as well as PCM over SDI. Additionally, real-time content formatted in NTSC and PAL technologies may be delivered to the network operations center 110. Real-time MediaFLO content and services may be implemented to bring television experiences, similar to those experienced on a traditional television, to a mobile device. For example, the television experiences may include general entertainment programming, such as live sporting events, news, music concerts, and weather updates.

Similarly, non-real-time content formatted in MPV, such as MPEG-4 audio and video clips, and data services via Clipcast (DSvC), such as JPEG, PNG and HTML files, also may be received at the network operations center 110. The network operations center 110 may process the non-real-time content and may schedule network delivery of the content to one or more mobile devices. MediaFLO's non-real-time content and file delivery may extend the user experience to include short clips, e.g., YouTube™ videos, and files of non-real-time content, e.g., stored audio files.

In addition, the system 100 may be implemented to deliver IP data services content, such as stock tickers, weather, and news updates to the network operations center 110. The IP data services content may include a broad range of information accessible to each MediaFLO subscriber. In some implementations, the IP data services content may be tailored to a user's specific profile. For example, a MediaFLO subscriber may choose to receive particular IP data services content, such as weather and sports scores, at their MediaFLO compatible mobile device. Both the non-real-time and IP data services content may be delivered to the network operations center 110 over one or more data networks.

In some implementations, the network operations center 110 may aggregate the content received from the one or more content providers 120. In some implementations, the network operations center 110 may include additional content, such as locally stored content in the multiplexed content data stream. In the system 100, there may be a number of wide broadcast areas (e.g., which each correspond to a different wide-area operational infrastructure (WOI) in the MediaFLO system). Within each wide broadcast area, there may be a number of local broadcast areas (e.g., which each correspond to a different local-area operational infrastructure (LOI) in the MediaFLO system). Wide broadcast area content may be transmitted to the wide broadcast area, while local broadcast area content may be specific to each local broadcast area. A central network operations center 110 may serve multiple WOIs and LOIs, or the network operations center 110 may be distributed geographically. In some instances, there may be a number of network operations centers 110 with a broadcast system.

Regardless of the particular architecture, content may be multiplexed at the network operations center 110 and distributed as a content data stream to the one or more transmitters 130. There may be a wide broadcast area transmitter 130 for transmitting wide broadcast area content, and a local broadcast area transmitter 130 for transmitting local broadcast area content. These transmitters 130 may each be geographically remote from each other, and from the network operations center 110. Because of this geographical diversity and other factors, a mobile device may be able to acquire the signal from one transmitter 130 (e.g., a WOI transmitter), but not another (e.g., a LOI transmitter). This use of different transmitters may cause coverage gaps to arise if content received on one transmitter 130 relies on control information from other transmitters.

Text, graphical, and video content transmitted from transmitters 130 may be received and displayed on a display screen at the mobile device 140. Audio content received from the transmitters 130 may be played back at one or more audio outputs at the mobile device 140. The mobile device 140 may include an external and internal memory module that may store the received content. In some implementations, the mobile device 140 may communicate with the network operations center 110 over a reverse link. The reverse links may be used to communicate information for mobile device 140 activations, service key distribution, subscriptions, and usage tracking.

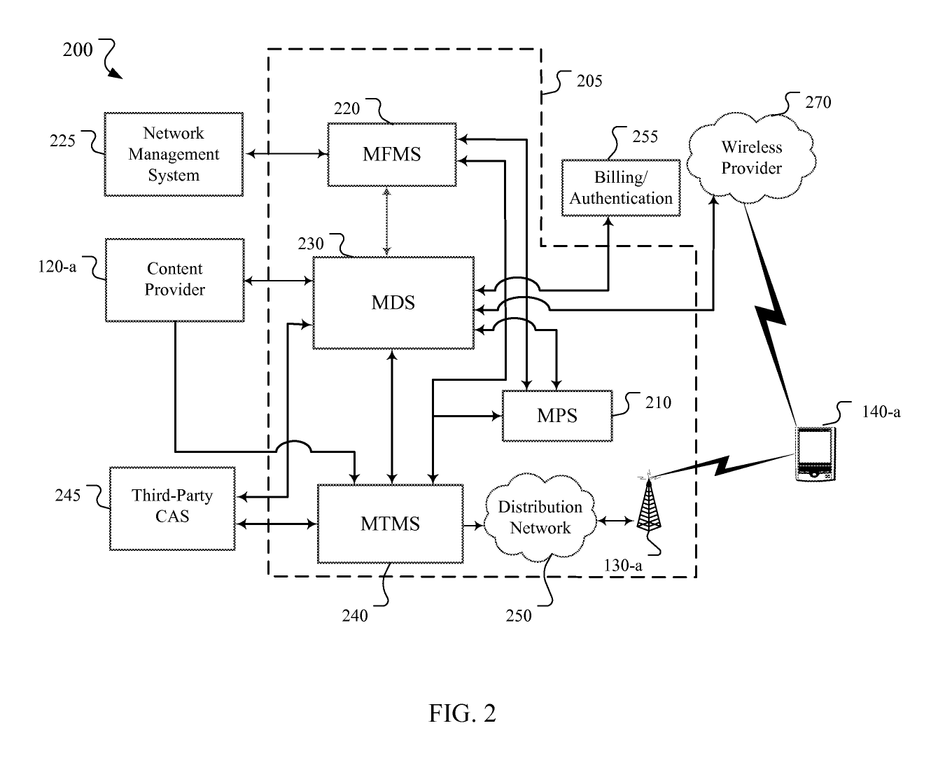

FIG. 2 is a block diagram illustrating an example of the MediaFLO system architecture 200. This architecture 200 includes one or more systems, subsystems, and components, a subset of which make up a MediaFLO network 205. The MediaFLO network 205 includes a MediaFLO Provisioning System (MPS) 210, a MediaFLO Management System (MFMS) 220, a MediaFLO Distribution System (MDS) 230, and a MediaFLO Transcode and Multiplex System (MTMS) 240. The MPS 210, MFMS 220, MDS 230, and MTMS 240 may make up all or part of the network operations center 110 of FIG. 1. In one example, the MediaFLO network 205 is implemented in the network operations center 110. The MediaFLO network 205 also includes a FLO Radio Access Network (RAN) subsystem, including the MTMS 240, a distribution network 250, and one or more FLO transmitters 130-a. The MediaFLO network 205 may be implemented to deliver real-time, non-real-time, and IP data services content to one or more mobile devices, such as a MediaFLO device 140-a.

The MPS 210 provides one or more interfaces for an operator to configure the MediaFLO network 205. The MPS 210 distributes the MediaFLO network 205 configuration to the various systems, subsystems, and components included in the MediaFLO network 205. In some implementations, the MPS 210 may provide one or more web services programming interfaces. Web and software developers may generate custom web services applications through the web service programming interface. For example, a MediaFLO developer using the MPS 210 programming interface may generate and offer custom subscription packages to MediaFLO subscribers. In addition, the MPS 210 may share data and information (i.e., transmit to and receive from) the MFMS 220, the MDS 230, and MTMS 240.

The MFMS 220 performs the operations, administration, and maintenance functions for the MediaFLO network 205. Specifically, the MFMS 220 may monitor the systems constituting the MediaFLO service platform, i.e., the MPS 210, the MDS 230, and the MTMS 240. Components outside the MediaFLO service platform may be monitored by other systems, subsystems, or components. The MFMS 220 may provide management interfaces to enable network, state, fault, security, performance, and log management within the MediaFLO network 205. Network management may include discovering new networks and nodes to monitor, deleting monitored nodes, controlling MediaFLO agents and components, such as reset counters, restarting components, and terminating components. For example, the MFMS 220 network management interface may be used to communicate with and control the network management system 225. The network management system 225 may be implemented to manage the MediaFLO network 205 within, or external to, the MediaFLO network 205.

State management may include monitoring the high availability state of MediaFLO components, managing the administrative state of MediaFLO components, and monitoring the operational state of MediaFLO components. Fault management may include managing events, alarms, and alarm maps, as well as performing fault recovery. For example, a network operator may clear one or more alarms using a client interface associated with the fault management server component of the MFMS 220. Security management may include controlling operator access to the element management system and fault management system. Performance and log management may include collecting statistics from MediaFLO components, providing threshold-based monitoring, and providing reports and graphical views for the Key Performance Indicators (KPI) generated from the statistics. KPIs may be derived from the statistics and may define and measure progress toward organizational goals. In addition, the MFMS 220 may share data and information with the MDS 230 and the MTMS 240.

The MDS 230 provides efficient distribution of encrypted content across one or more wireless networks. The wireless networks may include data optimized (DO) networks, DO-multicast networks, 3G or 4G networks, and FLO networks. The MDS 230 may maintain responsibility for aggregation and distribution of real-time content, non-real-time content, IP data services content, subscription services management, and FLO resource scheduling. Additionally, the MDS 230 may be implemented to perform configuration management for the MediaFLO network 205. The MDS 230 also may include one or more of the following subsystems: distribution; digital rights management (DRM); subscription, billing and service management; unicast request handling; and usage tracking.

The MDS 230 distribution subsystem interfaces with one or more content providers 120-a to receive real-time, non-real-time, and IP data services content from the one or more content providers 120-a. The MDS 230 functions to provide a user interface for streaming, Clipcast, and IP data services content. In some implementations, the MDS 230 distribution subsystem manages files, clips, and data content delivery. The MDS 230 distribution subsystem may also receive and consolidate program guide data from the content provider 120-a and other sources, e.g., Tribune Media Services. The consolidated guide is termed a MediaFLO Program Guide (MPG) and may be implemented as an easy-to-use guide that contains program description and file delivery information associated with MediaFLO end users. The MDS 230 distributes the content, the MPG, and subscription information to one or more mobile devices using a FLO transmitter 130-a or via a wireless provider 270.

The MDS 230 also may generate system information, such as overhead information, and may initiate distribution of the overhead information. In addition, the distribution subsystem may receive Clipcast content from content providers and may schedule clip delivery to mobile devices, such as a MediaFLO device 140-a, during contact windows. The MDS 230 distribution subsystem also may encrypt content for conditional access and apply forward-error-correction (FEC) encoding to improve reception probability at the MediaFLO device 140-a. Additionally, the MDS 230 distribution subsystem may be implemented to deliver content based on a network, or content provider, delivery schedule.

The MDS 230 DRM subsystem may distribute encryption keys to MediaFLO network 205 components. In addition, the MDS 230 DRM subsystem may securely distribute decryption keys to one or more MediaFLO devices 140-a. The MDS 230 DRM subsystem also may synchronize with one or more the third-party CAS 245. Third-party CAS 245 may provide protection of services on a per-user basis. For example, a third-party CAS 245 may black out specific programs in certain regions, or restrict content available to a particular market.

The MDS 230 subscription, billing, and service management (SBSM) subsystem may be implemented to make subscription-based billing predictable and readily understood. The SBSM subsystem may manage and provide MediaFLO content package subscriptions. For example, the SBSM subsystem may provide subscription services and a back-end billing interface 255 for the MediaFLO network 205. The back-end billing interface 255 may include billing and authentication information, in addition to authorization and accounting functions. Additionally, the SBSM subsystem may provide MediaFLO service management and may generate new and custom subscription packages. The SBSM subsystem may receive subscription information from one or more mobile devices. In some implementations, the SBSM subsystem may activate MediaFLO services for one or more subscribing mobile devices.

The MDS 230 unicast request handling subsystem may be implemented to manage functions related to unicast device-to-server interface protocols. The MDS 230 unicast request handling subsystem includes a unicast configuration server (UCS) and a usage tracking service request handler (UTSRH). The UCS may receive provisioned application upgrade information sent from the MPS 210. In some implementations, the MPS 210 maintains all application version information, whereas the UCS only maintains the latest application version information. The MediaFLO device 140-a generally receives application upgrade notifications via, e.g., a multicast notification delivery path from the wireless provider 270. However, when the MediaFLO device 140-a application version is out-of-date, the MediaFLO device 140-a may perform an application upgrade check via a unicast connection to the UCS to obtain the latest version information. The UTSRH may collect service usage and performance statistics from MediaFLO-enabled mobile devices. For example, the MediaFLO device 140-a may be instructed to log usage events and upload the logged usage tracking statistics to the UTSRH. The UTSRH may collect the usage tracking statistics from the MediaFLO device 140-a and may forward the usage tracking log to the usage tracking subsystem. In some implementations, usage tracking parameters may be transmitted to the MediaFLO device 140-a as part of the notification flow. The MediaFLO device 140-a may decide what events to log and when to log the usage tracking statistics based on the usage tracking parameters.

The MDS 230 usage tracking subsystem may receive the MediaFLO device's 140-a upload data from the UTSRH and may log the data in persistent storage. In some implementations, the MDS 230 usage tracking subsystem may collect upload data directly from the one or more MediaFLO-enabled mobile devices. The MDS 230 usage tracking subsystem may be implemented to share at least a portion of the usage tracking statistics with one or more third-party entities. In some implementations, the third-party entities may use the usage tracking statistics to measure MediaFLO users' service usage patterns. In addition, the MDS 230 may share data and information with the MTMS 240.

The MTMS 240 may be implemented to receive content from one or more content providers 120-a. The content may include real-time, non-real-time, and IP data services content. The MTMS 240 may aggregate the received content and may change the content into a format supported by one or more mobile devices. In some implementations, the MTMS 240 may encode the content received from the one or more content providers 120-a. For example, real-time, non-real-time, and IP data services content may be aggregated and transcoded at the MTMS 240 for delivery to the MediaFLO device 140-a. The MTMS 240 also may multiplex the received content before delivering encoded and multiplexed content to a distribution network 250. In some implementations, a multiplexer component of the MTMS 240 may aggregate the received content and alter the content into a MediaFLO supported format. Additionally, in some implementations, the multiplexer component may include a statistical multiplexer (Stat-MUX) that may be configured to change the bit rate of services according to the needs of different channels at different times. In statistical multiplexing, a communication channel may be divided into an arbitrary number of variable bit rate digital channels or data streams. The Stat-MUX may employ a more complex method of managing change in input channel bit rates which may result in a better utilization of bandwidth. For example, using the Stat-MUX, a MediaFLO network 205 operator may decrease the bit rate for generally static channel programming, like a newscast, while increasing the bit rate for more dynamic channel programming, like a basketball game. The MTMS 240 also may be implemented to encrypt content, in addition to determining resource allocation and distribution of content. Moreover, the MTMS 240 may communicate with one or more third-party CAS 245. In addition, the MTMS 240 may transmit data and information through the distribution network 250 to the FLO transmitter 130-a.

The distribution network 250 may receive encoded content from the MTMS 240 and may distribute the content to the one or more FLO transmitters 130-a. The FLO transmitter 130-a may receive encoded content from the MTMS 240 over the distribution network 250. The encoded content may include content belonging to wide broadcast area (corresponding to a WOI) and a local broadcast area (corresponding to a LOI). Generally, the wide area broadcast (WOI) content is associated with a wide-area broadcast signal that will be transmitted over a larger broadcast area than the local area broadcast (LOI) content, which is associated with a local-area broadcast signal. For example, the WOI content may be national news, and the LOI content may be regional or local news. The WOI and LOI content may be received by a FLO transmitter 130-a in distinct WOI and LOI signals, or in one or more combined signals. In some examples, there are different FLO transmitters 130 for the WOI and LOI signals. Thus, a FLO transmitter 130-a may be implemented to transmit the WOI content, the LOI content, or both, as a mobile broadcast signal to one or more mobile devices. The FLO transmitter 130-a may supply the content to MediaFLO-enabled mobile devices by transmitting a FLO waveform. For example, a FLO transmitter 130-a may transmit a FLO waveform including the WOI and LOI content to the MediaFLO device 140-a.

The MPS 210 (or other components of a network operations center 110) may assign each wide broadcast area content flow (e.g., programming for a particular channel) to a different wide broadcast area scrambling differentiator (e.g., assigning different programs transmitted in parallel to different wide area differentiators (WIDs)). The MPS 210 (or other components of a network operations center 110) may assign each wide broadcast area scrambling differentiator to a carrier tag (e.g., each WID may be assigned a different RF channel ID). The association between the wide broadcast area content, wide broadcast area scrambling differentiator, and the carrier tag may be common across neighboring wide broadcast areas. The association between the carrier tag and the wide broadcast area scrambling differentiator may be transmitted in a wide broadcast area control channel. This assignment of wide broadcast area scrambling differentiators and carrier tags will be discussed in more detail below.

It is worth noting that the carrier tag may be a symbolic channel identifier, as the assignment of a carrier to a carrier tag may differ in the local broadcast areas of a wide broadcast area (e.g., the same RF channel ID may be assigned different carriers in each different local broadcast area). The carrier assignments may be transmitted in local broadcast area control channels.

In some implementations, the FLO transmitter 130-a also may transmit content particular to a specific venue, or micro-venue. The content particular to the specific venue or micro-venue may be received from the MTMS 240 over the distribution network 250. Venues may include, e.g., sporting arenas, concert halls, movie theatres, shopping malls, or other such event locations. For example, the FLO transmitter 130-a may transmit player statistics associated with a baseball game to MediaFLO-enabled mobile devices residing within the confines, or surrounding area, of a baseball stadium. Micro-venues may include, e.g., office buildings, automobiles or other mobile objects, restaurants, shopping mall department stores or kiosks, or other more localized event locations. For example, the FLO transmitter 130-a may transmit sale-related data to users operating MediaFLO-enabled mobile devices within the confines, or surrounding area, of a department store. Additional information related to venue and micro-venue broadcasting may be found in U.S. patent application Ser. No. 12/569,792, filed Sep. 29, 2009, entitled “Apparatus and Methods of Providing and Receiving Venue Level Transmissions and Services,” the entire contents of which are incorporated by reference herein.

A FLO transmitter 130-a may include an exciter component and a transmitter component. The exciter component may receive ASI MPEG-2 transport streams and may perform proportional-integral-derivative (PID) filtering for the desired multiplex. The exciter component also may generate low power, e.g., less than 1-watt, FLO waveforms for the transmitter input. The transmitter component may generate RF signals that may be received over an air interface by one or more mobile devices. In some implementations, the transmitter may generate and transmit a FLO waveform using orthogonal frequency division multiplexing (OFDM). The transmitter also may be implemented to deliver RF signals to the MediaFLO device 140-a via broadcast, multicast and unicast methodologies.

In some implementations, the MTMS 240, the distribution network 250, and the FLO transmitter 130-a include the FLO RAN subsystem. The FLO RAN subsystem may receive real-time, non-real-time and IP data services content, and may perform audio and video encoding. The FLO RAN subsystem also may multiplex the received content and may distribute the multiplexed data streams. For example, the FLO RAN subsystem may receive real-time content, encode it, and multiplex it with other services, e.g., IP data services or DSvC, before encapsulating and distributing the content to FLO transmitters 130-a. Additionally, the FLO RAN subsystem may transmit one or more FLO waveforms to one or more mobile devices. For example, the FLO transmitter 130-a of the FLO RAN subsystem may transmit one or more FLO signals to the MediaFLO device 140-a. The MediaFLO device 140-a may be implemented to demodulate the FLO RF signal. Users operating the MediaFLO device 140-a may navigate through each of the MediaFLO supported services and may access content received at the device. In addition, MediaFLO device 140-a users may perform transaction-oriented operations with the MDS 230 over unicast connections through the wireless provider 270.

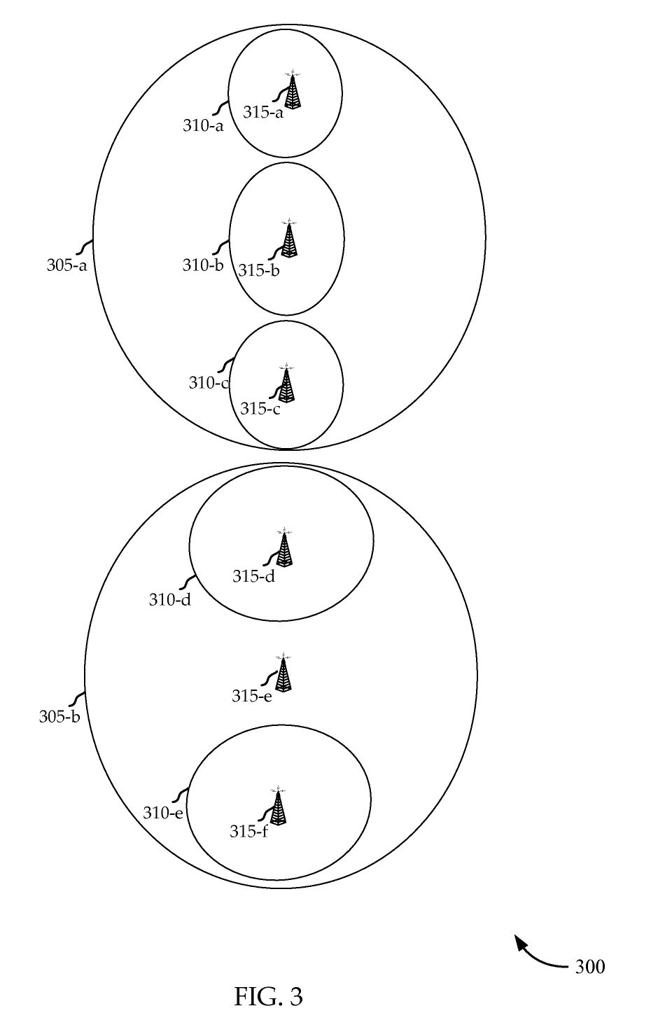

Referring next to FIG. 3, a diagram is shown illustrating broadcast areas in a wireless broadcast system 300. The diagram illustrates an example of how wide and local broadcast areas may be implemented in system 300, which may be the system 100, 200 of FIG. 1 or 2. In the system 300, there are two wide broadcast areas 305. Each may correspond to a different wide-area operational infrastructure (WOI). Within each wide broadcast area 305, there may be a number of local broadcast areas 310. Each may correspond to a different local-area operational infrastructure (LOI). Wide broadcast area content (which may be referred to as wide multiplex content) may be transmitted to the wide broadcast area 305 from centralized or decentralized transmitters (e.g., transmitter 315-b may transmit wide broadcast area content for wide broadcast area 305-a, while transmitter 315-e may transmit wide broadcast area content for wide broadcast area 305-b).

Local broadcast area content may be specific to each local broadcast area 310 (and may be referred to as local multiplex content). Local broadcast area content may be transmitted to the local broadcast area 310 from local transmitters 315 (e.g., transmitter 315-a may transmit local broadcast area content for local broadcast area 310-a; transmitter 315-c may transmit local broadcast area content for local broadcast area 310-c, transmitter 315-d may transmit local broadcast area content for local broadcast area 310-d; and transmitter 315-f may transmit local broadcast area content for local broadcast area 310-e). Some transmitters (e.g., 315-b) may transmit local and wide broadcast area content. A centralized network operations center (for example the network operations center 110 of FIG. 1) may serve multiple wide and local broadcast areas 305, 310, or the network operations center may be distributed geographically. In some instances, there may be a number of network operations centers 110 within broadcast system 300.

Wide broadcast area content (e.g., channels of programming) may be assigned to different wide broadcast area scrambling differentiators (e.g., assigned to different wide area differentiators (WIDs) in the MediaFLO system). Each wide broadcast area scrambling differentiator may be assigned to a carrier tag (e.g., each WID in a MediaFLO system may be assigned a different RF channel ID). The association between the wide broadcast area content, wide broadcast area scrambling differentiator, and the carrier tag may be common across neighboring wide broadcast areas. The association between the carrier tag and the wide broadcast area scrambling differentiator may be transmitted in a wide broadcast area control channel. However, the assignment of a carrier tag to specific carriers may be performed on a per-local broadcast area 310 basis.

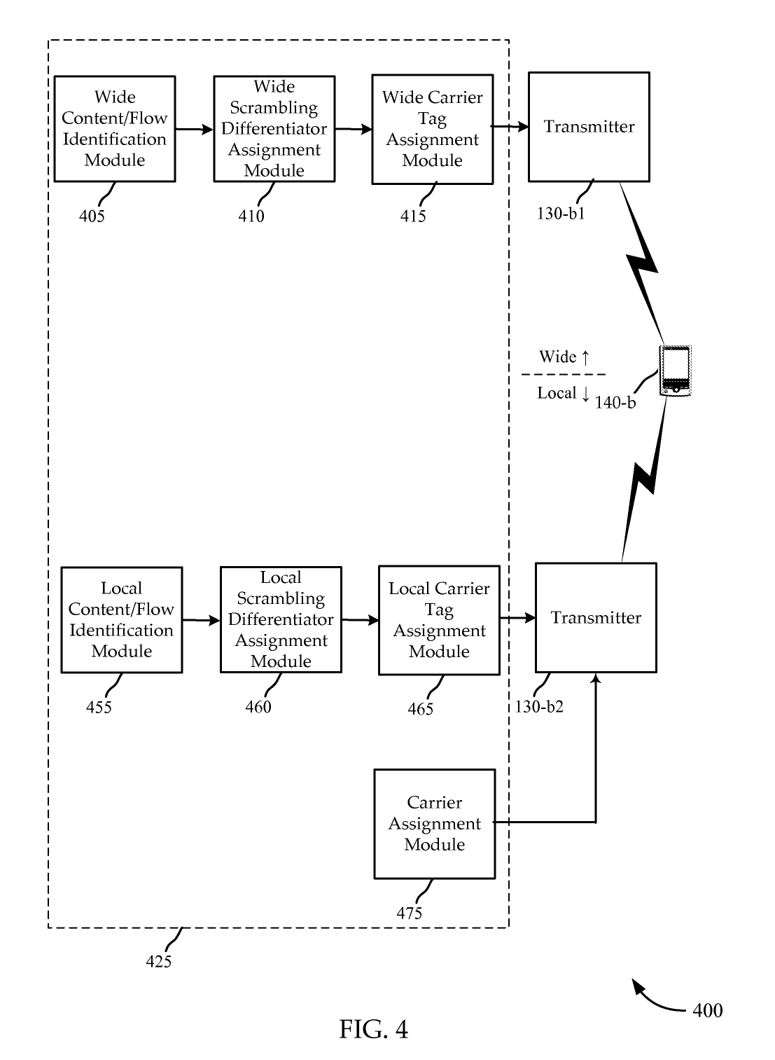

Turning next to FIG. 4, a block diagram illustrates a provisioning system 425, one or more transmitters 130, and a mobile device 140-b. The provisioning system 425 includes a wide content/flow identification module 405, a wide scrambling differentiator assignment module 410, a wide carrier tag assignment module 415, a local content/flow identification module 455, a local scrambling differentiator assignment module 460, a local carrier tag assignment module 465, and a carrier assignment module 475. The provisioning system 425 may be implemented in the network operations center 110 of FIG. 1 or the MediaFLO network 205 of FIG. 2.

The components of the provisioning system 425 may each be in communication with each other, and may be integrated into a single device or a set of local networked devices. In other examples, they may be geographically dispersed. These components may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. In one example, the wide broadcast area components 405, 410, 415 are geographically remote from the local broadcast area components 455, 460, 465, 475.

Assume a wireless broadcast communications system where there are a number of wide broadcast areas (e.g., the wide broadcast areas 305 of FIG. 3). These areas may correspond to the WOIs of a MediaFLO system. Within each wide broadcast area, there may be a number of local broadcast areas (e.g., the local broadcast areas 310 of FIG. 3). These areas may correspond to the LOIs of a MediaFLO system.

The wide content/flow identification module 405 may identify wide broadcast area content to be transmitted to wide broadcast areas. This content may be wide broadcast area content to be received from a content provider 120 of FIG. 1 or 2. The wide scrambling differentiator assignment module 410 may assign the identified wide broadcast area content to a wide broadcast area scrambling differentiator (e.g., wide area differentiators (WIDs) in the MediaFLO system). This wide broadcast area content assignment may be common across two or more neighboring wide broadcast areas. Each local broadcast area within neighboring wide broadcast areas may also reflect the common wide broadcast area content assignment. In one example, the wide broadcast area content assignment to the wide broadcast area scrambling differentiator may be common system wide.

The wide carrier tag assignment module 415 may assign each wide broadcast area scrambling differentiator to a carrier tag (e.g., assigning each WID to a different RF channel ID). The wide broadcast area scrambling differentiator assignment may be common across two or more neighboring wide broadcast areas. Each local broadcast area within neighboring wide broadcast areas may also reflect the wide broadcast area scrambling differentiator assignment to the carrier tag may be common system wide. Thus, in one example, the association between the wide broadcast area content, wide broadcast area scrambling differentiator, and the carrier tag may be common across neighboring local broadcast areas, wide broadcast areas, and/or system-wide. A wide broadcast area transmitter 130-b1 may transmit data in a wide broadcast area control channel identifying an association between the content, the carrier tag, and the wide broadcast area scrambling differentiator.

The wide carrier tag assignment module 415 may generate the carrier tag as a function of the wide broadcast area scrambling differentiator. More specifically, the carrier tag may include all or part of the wide broadcast area scrambling differentiator. Consider an example where the carrier tag is an eight bit number, and the wide broadcast area scrambling differentiator is a four bit number (for example, an RF channel ID and WID). In one example, for RFs carrying wide broadcast area content, the four least significant bits of the RF channel ID may simply be set as the WID value, and the four most significant bits may be set to 0. For RFs carrying local broadcast area content, the four most significant bits of the RF channel ID may simply be set as the LID value, and the four least significant bits may be set to 0 (this may, for example, be performed by the local carrier tag assignment module 465). A number of other examples will be apparent to those skilled in the art.

The local content/flow identification module 455 may identify local broadcast area content to be transmitted to one or more local broadcast areas. The local scrambling differentiator assignment module 460 may assign the identified local broadcast area content to a local broadcast area scrambling differentiator (e.g., local area differentiators (LIDs) in the MediaFLO system). The local carrier tag assignment module 465 may assign each local broadcast area scrambling differentiator to a carrier tag (e.g., assigning each LID to a different RF channel ID). A local broadcast area transmitter 130-b2 may transmit data in a local broadcast area control channel identifying an association between the carrier tag and the local broadcast area scrambling differentiator.

For each local broadcast area, a carrier assignment module 475 may assign a carrier to the local or wide broadcast area carrier tag. Different carriers may be assigned to a carrier tag in each of a number of neighboring local or wide broadcast areas (although in other examples, a same carrier may be assigned to a carrier tag across a number of local or wide broadcast areas). The local broadcast area transmitter 130-b2 may transmit data in a local broadcast area control channel identifying the carrier assignment (the carrier to carrier tag mapping) applicable to the local broadcast area. The local broadcast area transmitter 130-b2 may transmit data in a local broadcast area control channel identifying the carrier assignment (the carrier to carrier tag mapping) applicable to neighboring local broadcast areas of the applicable local broadcast area.

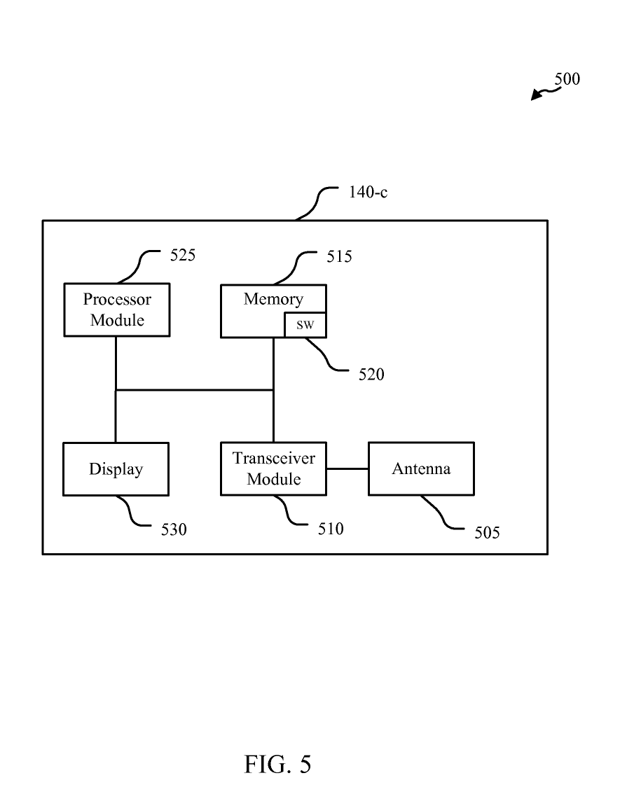

The local broadcast area control channel carrier assignment information (for a local broadcast area, and/or for neighboring local broadcast areas) may be cached by a mobile terminal 140-b. In some cases, a mobile device 140-b may not be able to acquire the local broadcast area control channel. However, the wide broadcast area content and control channel may be available. The mobile device 140-c may use the cached version of the carrier to carrier tag assignment for the local broadcast area and/or neighboring broadcast areas to access the desired content Referring next to FIG. 5, a block diagram 500 illustrates an example of a mobile device 140-c. This may, for example, be the mobile device of FIG. 1, 2, or 4. The mobile device 140-c includes an antenna 505, a transceiver module 510, memory 515, and a processor module 525, and display. 530, which each may be in communication, directly or indirectly, with each other. The transceiver module 510 is configured to communicate bi-directionally with the transmitters 130 of FIG. 1, 2, or 4. The memory 515 may include random access memory (RAM) and read-only memory (ROM). The memory 515 may store computer-readable, computer-executable software code 520 containing instructions that are configured to, when executed, cause the processor module 525 to perform various functions described herein. Alternatively, the software 520 may not be directly executable by the processor module 525 but is configured to cause the computer, e.g., when compiled and executed, to perform the functions.

The processor module 525 may include an intelligent hardware device, e.g., a central processing unit (CPU) such as those made by Intel® Corporation or AMD®, a microcontroller, an application specific integrated circuit (ASIC), etc. The processor module 525 may include a speech encoder (not shown) configured to receive audio via a microphone, convert the audio into packets (e.g., 20 ms in length) representative of the received audio, provide the audio packets to the transceiver module 510, and provide indications of whether a user is speaking. Alternatively, an encoder may only provide packets to the transceiver module 510, with the provision or withholding/suppression of the packet itself providing the indication of whether a user is speaking.

The transceiver module 510 may include a modem configured to modulate the packets and provide the modulated packets to the antenna 505 for transmission, and to demodulate packets received from the antenna 505. In some embodiments, the antenna 505 may be multiple antennas. The mobile device 140-c may communicate with the transmitters 130 via uplinks and downlinks using an active set of carriers. The downlink refers to the communication link from a transmitter 130 to the mobile device 140-c, and the uplink refers to the communication link from the mobile device 140-c to a transmitter 130.

The transceiver module 510 may receive a wide broadcast area control channel (e.g., from transmitter 130 of FIG. 1, 2, or 4). This may include a mapping of wide broadcast area content to a wide broadcast area scrambling differentiator, and/or of a wide broadcast area scrambling differentiator to a carrier tag. The memory 515 may store a cached version of the carrier assignment information (the carrier to carrier tag correspondence information for a local broadcast area, and/or for neighboring local broadcast areas) received from a transmitter via a local broadcast area control channel. Thus, even if a mobile device 140-c is unable to acquire the local control channel, the mobile device 140-c may rely on the wide broadcast area control channel and cached version of the mapping to access the wide broadcast content.

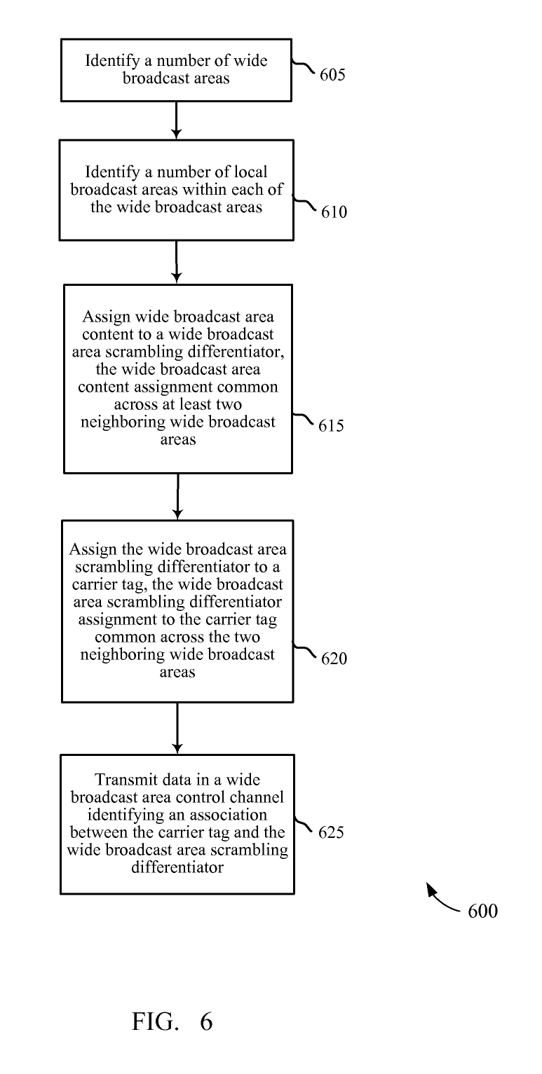

FIG. 6 is a flowchart of a method 600 for distributing wide broadcast area control channel information. The method 600 may be performed, for example, in whole or in part, by the network operations center 110 and transmitters 130 of FIG. 1, by the MediaFLO network 205 of FIG. 2, or by the provisioning system 400 of FIG. 4. The method 600 may, more specifically, be performed by the MPS 210 and transmitter 130 of FIG. 2.

At stage 605, a number of wide broadcast areas are identified. At stage 610, a number of local broadcast areas within each of the wide broadcast areas are identified. At stage 615, wide broadcast area content is assigned to a wide broadcast area scrambling differentiator, the wide broadcast area content assignment common across at least two neighboring wide broadcast areas. At stage 620, the wide broadcast area scrambling differentiator is assigned to a carrier tag, the wide broadcast area scrambling differentiator assignment to the carrier tag common across the two neighboring wide broadcast areas. At stage 625, data is transmitted in a wide broadcast area control channel identifying an association between the carrier tag and the wide broadcast area scrambling differentiator.

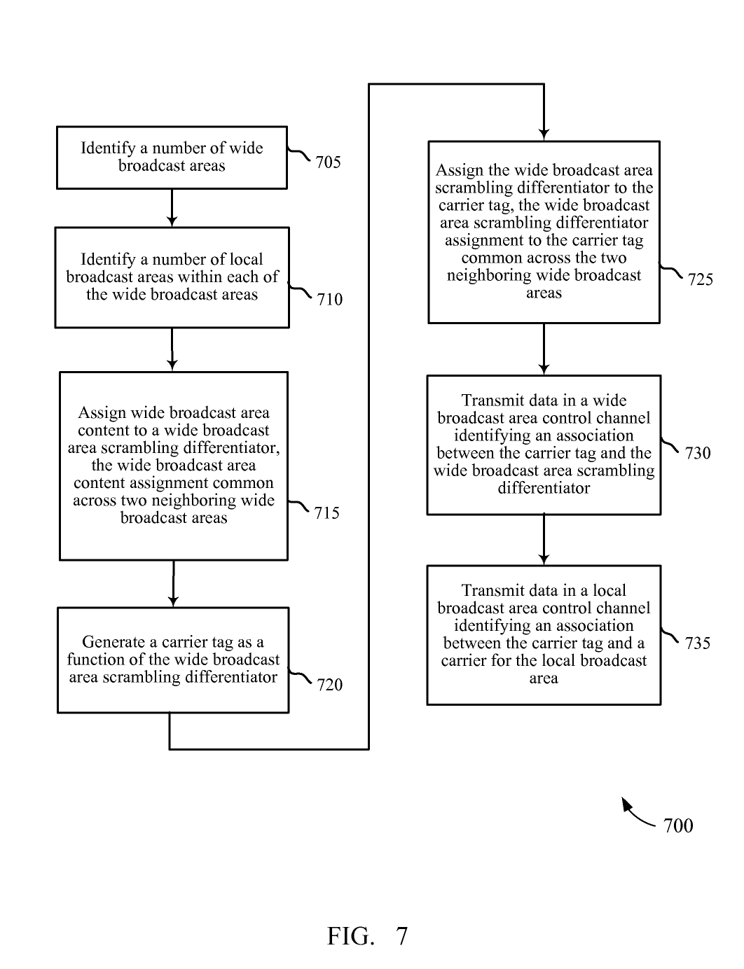

FIG. 7 is a flowchart of a method 700 for distributing wide and local broadcast area control channel information. The method 700 may be performed, for example, in whole or in part, by the network operations center 110 and transmitters 130 of FIG. 1, by the MediaFLO network 205 of FIG. 2, or by the provisioning system 400 of FIG. 4. The method 700 may, more specifically, be performed by the MPS 210 and transmitter 130 of FIG. 2.

At stage 705, a number of wide broadcast areas are identified. At stage 710, a number of local broadcast areas within each of the wide broadcast areas are identified. At stage 715, wide broadcast area content is assigned to a wide broadcast area scrambling differentiator, the wide broadcast area content assignment common across two neighboring wide broadcast areas. At stage 720, a carrier tag is generated as a function of the wide broadcast area scrambling differentiator. At stage 725, the wide broadcast area scrambling differentiator is assigned to the carrier tag, the wide broadcast area scrambling differentiator assignment to the carrier tag common across the two neighboring wide broadcast areas. At stage 730, data is transmitted in a wide broadcast area control channel identifying an association between the carrier tag and the wide broadcast area scrambling differentiator. At stage 735, data is transmitted in a local broadcast area control channel identifying an association between the carrier tag and a carrier for the local broadcast area.

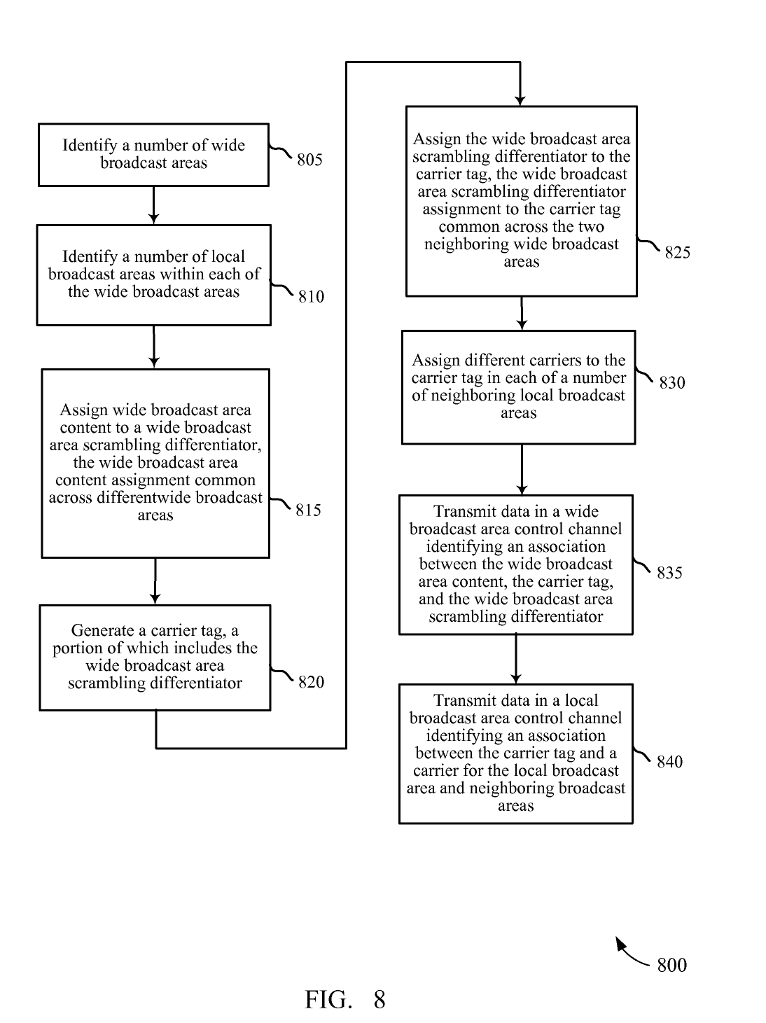

FIG. 8 is a flowchart of a alternative method 800 for distributing wide and local broadcast area control channel information. The method 800 may be performed, for example, in whole or in part, by the network operations center 110 and transmitters 130 of FIG. 1, by the MediaFLO network 205 of FIG. 2, or by the provisioning system 400 of FIG. 4. The method 800 may, more specifically, be performed by the MPS 210 and transmitter 130 of FIG. 2.

At stage 805, a number of wide broadcast areas are identified. At stage 810, a number of local broadcast areas within each of the wide broadcast areas are identified. At stage 815, wide broadcast area content is assigned to a wide broadcast area scrambling differentiator, the wide broadcast area content assignment common across different wide broadcast areas. At stage 820, a carrier tag is generated, a portion of which includes the wide broadcast area scrambling differentiator. At stage 825, the wide broadcast area scrambling differentiator is assigned to the carrier tag, the wide broadcast area scrambling differentiator assignment to the carrier tag common across the two neighboring wide broadcast areas.

At stage 830, different carriers are assigned to the carrier tag in each of a number of neighboring local broadcast areas. At stage 835, data is transmitted in a wide broadcast area control channel identifying an association between the wide broadcast area content, the carrier tag, and the wide broadcast area scrambling differentiator. At stage 840, data is transmitted in a local broadcast area control channel identifying an association between the carrier tag and a carrier for the local broadcast area and neighboring broadcast areas. The local broadcast area control channel carrier assignment information (for a local broadcast area, and/or for neighboring local broadcast areas) may be cached and used later by a mobile terminal if a local control channel cannot be acquired.

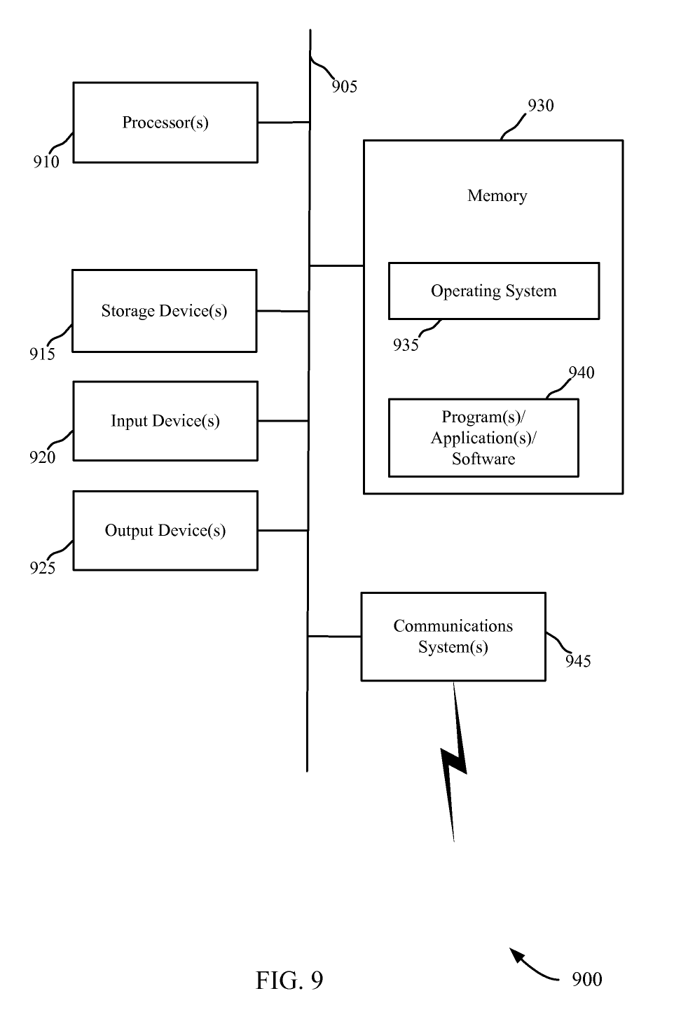

A structure 900 that may be used in all or part of the network operations center 110 and/or transmitter 130 of FIG. 1, the MediaFLO network 205 of FIG. 2, or provisioning system 400 of FIG. 4, any components thereof, or for other computing devices described herein, is illustrated with the schematic diagram of FIG. 9. This drawing broadly illustrates how individual system elements of each of the aforementioned devices may be implemented, whether in a separated or more integrated manner. The example structure is shown made up of hardware elements that are electrically coupled via bus 905, including processor(s) 910 (which may further comprise a DSP or special-purpose processor), storage device(s) 915, input device(s) 920, and output device(s) 925. The storage device(s) 915 may be a machine-readable storage media reader connected to any machine-readable storage medium, the combination comprehensively representing remote, local, fixed, or removable storage devices or storage media for temporarily or more permanently containing computer-readable information. The communications system(s) interface 945 may interface to a wired, wireless, or other type of interfacing connection that permits data to be exchanged with other devices. The communications system(s) 945 may permit data to be exchanged with a network.

The structure 900 may also include additional software elements, shown as being currently located within working memory 930, including an operating system 935 and other code 940, such as programs or applications designed to implement methods of the invention. The code 940 may contain instructions that are configured to, when executed, cause the processor(s) 910 to perform various functions described herein. Alternatively, the code 940 may not be directly executable by the processor(s) 910 but may be configured to cause the computer, e.g., when compiled and executed, to perform the functions. It will be apparent to those skilled in the art that substantial variations may be used in accordance with specific requirements. For example, customized hardware might also be used, or particular elements might be implemented in hardware, software (including portable software, such as applets), or both.

### CONSIDERATIONS REGARDING THE DESCRIPTION

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of generating tags for a broadcast communications system, the method comprising:
identifying a plurality of wide broadcast areas,
identifying a plurality of local broadcast areas within each of at least a subset of the wide broadcast areas;
assigning wide broadcast area content to a wide broadcast area scrambling differentiator, the wide broadcast area content assignment common across at least two neighboring wide broadcast areas of the plurality of wide broadcast areas;
assigning the wide broadcast area scrambling differentiator to a carrier tag, the wide broadcast area scrambling differentiator assignment to the carrier tag common across the at least two neighboring wide broadcast areas; and
transmitting data in a wide broadcast area control channel identifying an association between the carrier tag and the wide broadcast area scrambling differentiator.

2. The method of claim 1, wherein the assigning the wide broadcast area scrambling differentiator to the carrier tag comprises:
assigning a same wide broadcast area scrambling differentiator to the carrier tag across each of the plurality of local broadcast areas within the two neighboring wide broadcast areas.

3. The method of claim 1, wherein the assigning the wide broadcast area scrambling differentiator to the carrier tag comprises:
assigning a same wide broadcast area scrambling differentiator to the carrier tag across in each of the plurality of wide broadcast areas.

4. The method of claim 1, further comprising:
assigning different carriers to the carrier tag in each of a plurality of neighboring local broadcast areas of the plurality of local broadcast areas.

5. The method of claim 4, further comprising:
transmitting data identifying the carrier assignment for a local broadcast area in a local broadcast area control channel.

6. The method of claim 5, wherein an mobile device acquiring the wide broadcast area control channel and unable to acquire the local broadcast area control channel uses a previously received neighbor list including the carrier assignment to receive the wide broadcast area content.

7. The method of claim 6, further comprising:
generating the carrier tag as a function of the wide broadcast area scrambling differentiator.

8. The method of claim 7, wherein the carrier tag comprises the wide broadcast area scrambling differentiator.

9. The method of claim 4, further comprising:
transmitting data identifying the carrier assignment for neighboring local broadcast areas in a local broadcast area control channel, wherein the carrier tag is generated as a function of the wide broadcast area scrambling differentiator.

10. The method of claim 1, further comprising:
assigning a carrier to the carrier tag, the carrier assignment common across a plurality of neighboring local broadcast areas within at least one of the wide broadcast areas.

11. The method of claim 1, wherein,
the broadcast communication system comprises a MediaFLO system;
the plurality of wide broadcast areas each correspond to a different wide-area operational infrastructure;
the plurality of local broadcast areas each correspond to a different local-area operational infrastructure;
the wide broadcast area scrambling differentiator comprises a wide area differentiator; and
the carrier tag comprises an RF channel ID.

12. A system of generating tags for a broadcast communications system, the system comprising:
a wide content identification module configured to identify wide broadcast area content to be transmitted to a plurality of wide broadcast areas, each of at least a subset of the wide broadcast areas including a plurality of local broadcast areas;
a wide scrambling differentiator assignment module, communicatively coupled with the wide content identification module, and configured to assign the identified wide broadcast area content to a wide broadcast area scrambling differentiator, the wide broadcast area content assignment common across at least two neighboring wide broadcast areas of the plurality of wide broadcast areas;
a carrier tag assignment module, communicatively coupled with the wide scrambling differentiator assignment module, and configured to assign the wide broadcast area scrambling differentiator to a carrier tag, the wide broadcast area scrambling differentiator assignment to the carrier tag common across the at least two neighboring wide broadcast areas; and
a wide broadcast area transmitter configured to transmit data in a wide broadcast area control channel identifying an association between the carrier tag and the wide broadcast area scrambling differentiator.

13. The system of claim 12, wherein the carrier tag assignment module is configured to:
assign a same wide broadcast area scrambling differentiator to the carrier tag across each of the plurality of local broadcast areas within the two neighboring wide broadcast areas.

14. The system of claim 12, wherein the carrier tag assignment module is configured to:
assign a same wide broadcast area scrambling differentiator to the carrier tag across in each of the plurality of wide broadcast areas.

15. The system of claim 12, further comprising a carrier assignment module, communicatively coupled with the carrier tag assignment module, and configured to:
assign different carriers to the carrier tag in the plurality of local broadcast areas.

16. The system of claim 15, further comprising a local broadcast area transmitter configured to:
transmit data identifying the carrier assignment for a local broadcast area in a local broadcast area control channel.

17. The system of claim 16, wherein an mobile device acquiring the wide broadcast area control channel and unable to acquire the local broadcast area control channel uses a previously received carrier assignment to receive the wide broadcast area content.

18. The system of claim 17, wherein the carrier tag assignment module is further configured to:
generate the carrier tag as a function of the wide broadcast area scrambling differentiator.

19. The system of claim 18, wherein the carrier tag comprises the wide broadcast area scrambling differentiator.

20. The system of claim 15, further comprising a local broadcast area transmitter configured to:
transmit data identifying the carrier assignment for neighboring local broadcast areas in a local broadcast area control channel.

21. The system of claim 15, further comprising a carrier assignment module, communicatively coupled with the carrier tag assignment module, and configured to:
assign a carrier to the carrier tag, the carrier assignment common across each of the plurality of local broadcast areas within at least one of the wide broadcast areas.

22. An apparatus for generating tags for a broadcast communication system, the apparatus comprising:
means for identifying a plurality of wide broadcast areas,
means for identifying a plurality of local broadcast areas within each of at least a subset of the wide broadcast areas;
means for assigning wide broadcast area content to a wide broadcast area scrambling differentiator, the wide broadcast area content assignment common across at least two neighboring wide broadcast areas of the plurality of wide broadcast areas;
means for assigning the wide broadcast area scrambling differentiator to a carrier tag, the wide broadcast area scrambling differentiator assignment to the carrier tag common across two neighboring wide broadcast areas of the plurality of wide broadcast areas; and
means for transmitting data in a wide broadcast area control channel identifying an association between the carrier tag and the wide broadcast area scrambling differentiator.

23. The apparatus of claim 22, wherein the means for assigning the wide broadcast area scrambling differentiator to the carrier tag comprises:
means for assigning a same wide broadcast area scrambling differentiator to the carrier tag across each of the plurality of local broadcast areas within the two neighboring wide broadcast areas.

24. The apparatus of claim 22, further comprising:
means for assigning different carriers to the carrier tag in two or more local broadcast areas of the plurality of local broadcast areas.

25. The apparatus of claim 24, further comprising:
means for transmitting data identifying the carrier assignment for a local broadcast area in a local broadcast area control channel.

26. The apparatus of claim 24, wherein,
a mobile device acquiring the wide broadcast area control channel and unable to acquire a local broadcast area control channel uses a previously received neighbor list including a carrier assignment to receive the wide broadcast area content; and
the carrier tag is generated as a function of the wide broadcast area scrambling differentiator.

27. The apparatus of claim 22, further comprising:
means for generating the carrier tag as a function of the wide broadcast area scrambling differentiator.

28. The apparatus of claim 27, wherein the carrier tag comprises the wide broadcast area scrambling differentiator.

29. A computer program product residing on a tangible processor-readable medium and comprising processor-readable instructions configured to cause a processor to:
identify a plurality of wide broadcast areas,
identify a plurality of local broadcast areas within each of at least a subset of the wide broadcast areas;
assign wide broadcast area content to a wide broadcast area scrambling differentiator, the wide broadcast area content assignment common across at least two neighboring wide broadcast areas of the plurality of wide broadcast areas;
assign the wide broadcast area scrambling differentiator to a carrier tag, the wide broadcast area scrambling differentiator assignment to the carrier tag common across two neighboring wide broadcast areas of the plurality of wide broadcast areas; and
transmit data in a wide broadcast area control channel identifying an association between the carrier tag and the wide broadcast area scrambling differentiator.

30. A broadcast communications system comprising:
a network operations center configured to:
identify a plurality of wide broadcast areas,
identify a plurality of local broadcast areas within each of at least a subset of the wide broadcast areas;
assign wide broadcast area content to a wide broadcast area scrambling differentiator, the wide broadcast area content assignment common across at least two neighboring wide broadcast areas of the plurality of wide broadcast areas; and
assign the wide broadcast area scrambling differentiator to a carrier tag, the wide broadcast area scrambling differentiator assignment to the carrier tag common across two neighboring wide broadcast areas of the plurality of wide broadcast areas;
a wide broadcast area transmitter in communication with the network operations center, and configured to transmit data in a wide broadcast area control channel identifying an association between the carrier tag and the wide broadcast area scrambling differentiator; and
an mobile device configured to wirelessly receive the wide broadcast area control channel.

31. The broadcast communications system of claim 30, wherein the network operations center is further configured to
assign different carriers to the carrier tag in each of a plurality of neighboring local broadcast areas of the plurality of local broadcast areas.

32. The broadcast communications system of claim 31, further comprising a local broadcast area transmitter in communication with the network operations center, and configured to:
transmit data identifying the carrier assignment for a local broadcast area in a local broadcast area control channel.

33. The broadcast communications system of claim 32, wherein the mobile device is further configured to use a cached carrier assignment received via the local control channel to receive the wide broadcast area content if unable to acquire the local broadcast area control channel in real-time.

34. The broadcast communications system of claim 32, wherein the local broadcast area transmitter is remote from the network operations center and the wide broadcast area transmitter.

35. The broadcast communications system of claim 31, further comprising a local broadcast area transmitter in communication with the network operations center, and configured to:
transmit data identifying the carrier assignment for neighboring local broadcast areas in a local broadcast area control channel.

36. The broadcast communications system of claim 35, wherein the mobile device is further configured to use a cached list of neighbor carrier assignments received via the local control channel to receive the wide broadcast area content if unable to acquire the local broadcast area control channel in real-time.

37. The broadcast communications system of claim 30, wherein the network operations center is further configured to
generate the carrier tag as a function of the wide broadcast area scrambling differentiator.

38. The broadcast communications system of claim 30, wherein the carrier tag comprises the wide broadcast area scrambling differentiator.
